(19) United States
(12) Patent Application Publication
(10) Pub. No.: US 2002/0135617 A1
(43) Pub. Date: Sep. 26, 2002

(54) Proactive desktop portal

(75) Inventor: Yaron Samid, Tel Aviv (IL)

Correspondence Address: G.E. EHRLICH (1995) LTD., c/o ANTHONY CASTORINA, 2001 JEFFERSON DAVIS HIGHWAY, SUITE 207, ARLINGTON, VA, 22202, US

(73) Assignee: BackWeb Technologies Ltd.

(21) Appl. No.: 10/059,181

(22) Filed: Jan. 31, 2002

Related U.S. Application Data
(60) Provisional application No. 60/277,962, filed on Mar. 23, 2001.

(51) Int. Cl. G09G 5/00

(52) U.S. Cl. 345/764

(57) ABSTRACT

A data portal for monitoring and downloading data from a data source comprising an interface application at a user client for displaying information integrally within a bar within an active one of a plurality of application windows and for maintaining the display in a new active window following exchange with a current active window so as to continuously display the information irrespective of exchanging active windows. Also described is a readable storage device for storing the interface application and a method and system for viewing continuously displayed data.

This Application claims the benefit of priority from U.S. Provisional Patent Application No. 60/277,962, filed Mar. 23, 2001.

### FIELD AND BACKGROUND OF THE INVENTION

The present invention relates to the field of data source access and, more particularly, to a desktop mounted data portal which provides broad access to data, transparent downloading and a versatile display capability, while consuming very little screen area.

One of the challenges presented by the proliferation of information stored digitally within Web sites and databases is to entice users to visit websites and to view the contents thereof. One of the challenges to businesses and other publishers of Web sites and databases, particularly those with products or services to sell, is to make access easy and attractive. Accordingly, such publishers often advertise widely and arrange to have their sites and databases easily found by the myriad search engines, browsers and web crawlers that are continually seeking data for users of computing devices. In

Computing network systems typically employ a portal through which users are able to gain access to communications networks and databases. The portal may include an access capability, a search capability, a downloading capability and a graphical user interface. Many portals presently compete in the consumer marketplace. Indeed, there is great impetus to design the most “friendly” portal in order to attract the greatest number of users.

Features that contribute to the usefulness and utility of a portal are the degrees to which it provides a versatile and visible entry without consuming display screen area; provides broad access to sites and sources; receives data without user delay; and provides data to users effectively.

Many examples exist of portals that include concise desktop displays and that provide data to users. Some of those in common use include the following:

Infogate, Inc., provides an Internet toolbar and personalized alerting service which enables users to automatically receive data and to interact with Websites. However, it is limited in that it only downloads content from its own proprietary server. Therefore, it only automatically downloads a small amount of content; the remainder of data is accessed by a user via a navigation guide to online content. In addition, its screen display is not concise, the default display consuming approximately 90 pixels of vertical screen area.

Newstitle by Backweb Technologies, which is essentially a news and stock ticker which continually scrolls in the titlebar of an active application window. While this product makes very efficient use of screen area by being confined to the titlebar, it limits normal screen function such as moving the window around the screen and maximizing and collapsing the window. Moreover, it has the disability of becoming a distraction to the user by continually scrolling

Google, Inc. provides a toolbar which is a downloadable extension to the Internet Explorer (IE) browser that allows users to access its proprietary search engine and sites database without visiting the search engine page directly. The Google Toolbar is an additional toolbar added to the IE browser toolbar, and, as such, consumes useful screen area. Moreover, it can only be displayed in the IE browser window, so is not visible when other application windows are displayed.

All of the above listed portals, as well as the other examples of prior art, suffer deficiencies in one or more of the desired features. There is thus a widely recognized need for a portal that is continually visible on a display screen but that consumes little or no usable screen area; that is “personalizable” in that a user can customize the display according to desires; that automatically provides access to a broad range of data sources; that uploads to a user client without making the user wait an inordinately long period; and that provides offline access to downloaded data.

### SUMMARY OF THE INVENTION

According to one aspect of the present invention there is provided a data portal which comprises at least one server for monitoring and downloading data accessible via a communications network and for uploading data to at least one user client; and an interface for receiving the data, for displaying the data integrally within an active application window and for maintaining the display in a new active window following exchange with a current active window so the information is continuously displayed.

According to another aspect of the present invention there is provided a data portal which is capable of sending an agent to a data source which is capable of monitoring and downloading data and is further capable of transferring data from the data source to a user client, said user client storing said data in said memory; and an interface for receiving the data, for displaying the data integrally within an active application window and for maintaining the display in a new active window following exchange with a current active window so the information is continuously displayed.

According to another aspect of the present invention there is provided an interface application supportable by a user client comprising active window display functionality for displaying information integrally within an active application window, and active window follower functionality for maintaining the display in a new active window following exchange with a current active window so the information is continuously displayable.

According to another aspect of the present invention there is provided a machine-readable storage device an interface application comprising active window display functionality for displaying information integrally within an active application window, and active window follower functionality for maintaining the display in a new active window following exchange with a current active window so the information is continuously displayable.

According to another aspect of the present invention there is provided an interface application comprising bar display functionality for displaying information integrally within a bar within an active application window independently of a respective application associated with said active window.

According to another aspect of the present invention there is provided a method of viewing data accessible via a communications network, comprising the steps of selecting at least one data source; connecting to a server to monitor the data source and to download data therefrom; receiving the data from the data source; displaying information integrally within an active application window; and moving the display to a new active window following exchange with a current active window so the information is continuously displayed.

According to another aspect of the present invention there is provided a method of supporting continuous display of information at a user client comprising the steps of supplying at least one user client having a memory and a screen display with an interface application; monitoring at least one data source; downloading data from the data source; uploading the data to the user client for storage in the memory; and via the interface application, retrieving the data from the memory and displaying it integrally within an active application window appearing on said screen display and moving the display to a new active window following exchange with a current active window so the information is continuously displayed.

According to another aspect of the present invention there is provided a system for viewing data comprising a server for accessing a data source via a communications network, downloading data from the data source and uploading the data to a user client; and a user client supporting an interface for displaying information integrally within an active application window and for moving the display to a new active window following exchange with a current active window so the information is continuously displayed.

According to features in the described preferred embodiments at least some of the application windows relate to independent applications.

According to features in the described preferred embodiments the server provides for user selection of data for uploading.

According to features in the described preferred embodiments the interface is capable of storing said uploaded data in a memory of a user client.

According to features in the described preferred embodiments the bar that is within the active application window appears at the top of, at the bottom of, at the side of or central to the active application window.

According to features in the described preferred embodiments the bar comprises information superimposed on existing window bar functionality.

According to features in the described preferred embodiments the information displayed comprises the uploaded data, notification that the data is stored in the memory and links for retrieving the data from the memory.

According to features in the described preferred embodiments the information displayed integrally within the bar is configurable to consume less than the entire span of the bar.

According to features in the described preferred embodiments the information displayed integrally within the bar is configurable to dissolve in and out of visibility.

According to features in the described preferred embodiments the interface is capable of displaying the information in the active window when the user is offline.

According to features in the described preferred embodiments the interface comprises a user operable function for making the information display invisible.

According to features in the described preferred embodiments the interface comprises a user operable function for making the information display larger and smaller.

According to features in the described preferred embodiments the interface application comprises a user operable function for revising the configuration of the information display.

According to features in the described preferred embodiments the communications network is the Internet.

According to features in the described preferred embodiments the server Is capable of monitoring and downloading data from at least one website selected by a user.

According to features in the described preferred embodiments the server is capable of identifying data designated by the website for downloading, updates and changes to the website and dynamically changing data.

The present invention successfully addresses the shortcomings of the presently known configurations by providing a portal that is continually visible on a display screen but that appears in a bar that consumes little or no usable screen area; that may be “personalized” by a user to his/her requirements; that provides automatic access to a broad range of data; that uploads to a user client without making the user wait an inordinately long period; and that provides offline access to downloaded data.

### BRIEF DESCRIPTION OF THE DRAWINGS

With specific reference now to the drawings in detail, it is stressed that the particulars shown are by way of example and for the purposes of illustrative discussion of the preferred embodiment of the present invention only, and are presented in the cause of providing what is believed to be the most useful and readily understood description of the principles and conceptual aspects of the invention. In this regard, no attempt is made to show structural details of the invention in more detail that is necessary for a fundamental understanding of the invention, the description taken with the drawings making apparent to those skilled in the art how the several forms of the invention may be embodied in practice.

In the drawings:

FIG. 1 is a black box diagram illustrating the components of a data portal constructed in accordance with the present invention;

FIG. 2 is a black box diagram illustrating a system for accessing data from a communications network in accordance with the present invention;

FIG. 3 is a black box diagram illustrating a system for accessing data from a data source in accordance with the present invention;

FIG. 4 is a black box diagram illustrating the functional components of the interface application of the data portal of FIG. 1;

FIG. 5 is a schematic illustration of a computer monitor with information provided by the portal of FIG. 1 displayed in a display screen thereof;

FIG. 6 is a photographic representation of a display screen with information provided by the portal of FIG. 1 displayed thereon; and

FIG. 7 is a flow chart depicting the steps of the method of viewing data via the portal of FIG. 1.

### DESCRIPTION OF THE PREFERRED EMBODIMENTS

Before explaining at least one embodiment of the invention in detail, it is to be understood that the invention is not limited in this application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The principles and operation of a data portal according to the present invention may be better understood with reference to the drawings and accompanying descriptions.

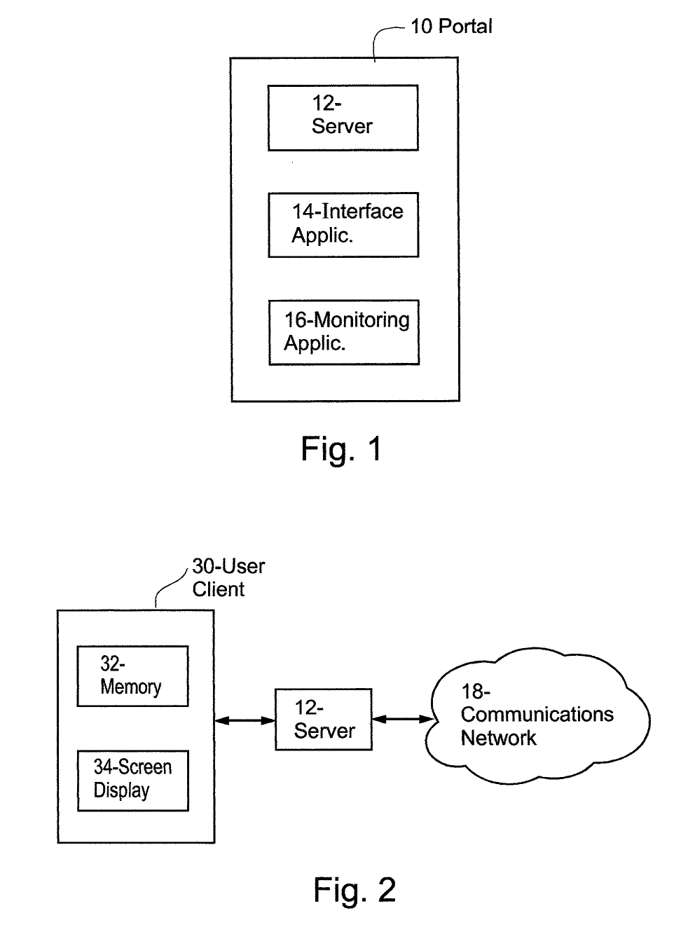

Reference is now made to FIG. 1 which is a simplified block diagram showing a data portal in accordance with an embodiment of the present invention. A portal 10 comprises a server 12, which may comprise a computing platform, such as a personal computer, workstation or mainframe capable of processing, storing and preferably communicating information over a communications network such as the Internet. In the described preferred embodiment, server 12 monitors and downloads data from websites and uploads this data to a user client, which is a computing device hereinafter referred to as user client 30. As used herein, the term “computing device” includes, but is not limited to, personal desktop or laptop computers (PC) having an operating system such as DOS, Windows, OS or Linux; Macintosh^{TI} computers; computers having JAVA^{TI}_OS as the operating system; graphical workstations such as the computers of Sun Microsystems^{TI} and Silicon Graphics^{TI}, and other computers having some version of the UNIX operating system such as AIX^{TI} or SOLARIS^{TI} of Sun Microsystems^{TI}; or any other known and available operating system. The term also includes any other stationary or portable device in which two or more applications can simultaneously be windowed and wherein one of the applications is typically active at any given time.

Portal 10 preferably comprises a user side interface application, hereinafter interface 14, which in the preferred embodiment is sent to and installed by user client 30. User client 30 preferably comprises a memory 32 and a display screen 34.

Portal 10 is referred to as a proactive portal because of the property of server 12 of automatically monitoring and downloading data from Web sites and thereafter automatically uploading the data to a user client. Existing portals customarily require a three step user initiated process; users must go online, they must access a destination Web site and they must affirmatively download data therefrom. Portal 10 automates the action of existing portals by carrying out the second and third step without user initiation. Portal 10 automatically monitors and downloads data from preselected Web sites or data sources and automatically uploads the data to a predetermined user client.

As used herein, the term “Web site” refers to at least one Web page, and preferably a plurality of Web pages, virtually connected to form a coherent group of interlinked documents. The term “Web page” refers to any document written in a mark-up language including, but not limited to, HTML (hypertext mark-up language) or VRML (virtual reality modeling language), dynamic HTML, XML (extended mark-up language), WML, or related computer languages thereof, as well as to any collection of such documents reachable through one specific Internet address or at one specific World Wide Web site, or any document obtainable through a particular URL (Uniform Resource Locator). It will be appreciated that the invention is however applicable to any other data source.

The automated process referred to above has, inter alia, two effects as follows: First, because the user does not initiate the monitoring and downloading, the monitoring and downloading occur in a “transparent” manner. Server 12 automatically leverages a robust Web browser in order to monitor user selected Web sites and download content therefrom. Such monitoring and downloading by server 12 occurs continually, irrespective of whether user client 30 is off line. Content downloaded is stored by server 12 so that it can be uploaded to user client 30 when user client 30 goes online.

Second, uploading to user client 30 also does not require user initiation. Therefore, it too occurs in a “transparent” manner. Although uploading requires user client 30 to be on line, data is preferably uploaded while the user is not actively using the Internet connection. Typically, a user may go on line in order to browse or to access a particular Web site and either view or download content therefrom. In both cases, the active transfer of data takes a very short time, yet the user typically remains online while browsing or viewing the Web site content. It is only during the active transfer of data that the user client occupies the entire available bandwidth. During the remainder of the time on line, the unused bandwidth is available for other purposes. Portal 10 takes advantage of the bandwidth availability. Using push technology, data is uploaded using available network bandwidth. Uploading initiates, pauses and resumes automatically depending on the user's bandwidth availability. Therefore, even large file and broadband media delivery takes place seamlessly and in a completely transparent manner over low bandwidth connections without causing the user to wait. Push technology is a term that describes data distribution technology in which selected data is automatically delivered into the user's computer at prescribed intervals or based on some event that occurs. This term is to be contrasted with pull technology, in which the user specifically asks for something by performing a search or requesting an existing report, video or other data type. Such transparent downloading and uploading is a feature of interest to content providers who wish to target users regardless of their Internet connection speed or frequency of use.

Portal 10 is versatile in its ability to access, monitor and download data from different sources. Reference is now made to FIG. 2, which is a simplified block diagram showing a system for viewing data accessed by user client 30 from a communications network in accordance with the preferred embodiment. User client 30, which is communication enabled, communicates with server 12, which in turn communicates with communications network 18, which in the preferred embodiment is the Internet. Server 12 monitors and downloads data from user selected Web sites from among the Websites that server 12 is programmed to monitor and from online web servers, file databases, ftp sites, Etc. Thereafter, server 12 uploads the downloaded data to user client 30 with data published on the internet. The data uploaded to the user client 30 may be stored in memory 32 for later display on display screen 34 or may be displayed directly upon receipt, depending upon the nature of the data and instructions programmed into interface application 14. As used herein, the term “communications network” preferably refers to the Internet as manifested by the World Wide Web (WWW) of computers, although the system of the present invention can also be implemented within Intranets or Extranets or any other open or closed communications network.

The monitoring and downloading process is preferably subject to three layers of selection, resulting in the desired data being delivered to the appropriate user client. The process begins with a Website publisher or data source proprietor acquiring the services of portal 10 from a provider. As a result, server 12 may monitor that Website or data source, along with the other Websites and data sources that it monitors. Second, a user who wishes to utilize portal 10 may select from among all of the Websites and data sources monitored by server 12 the Websites and data sources from which he/she wishes to receive data. Finally, the Website or data source may determine the content to be downloaded therefrom and provided to the user client.

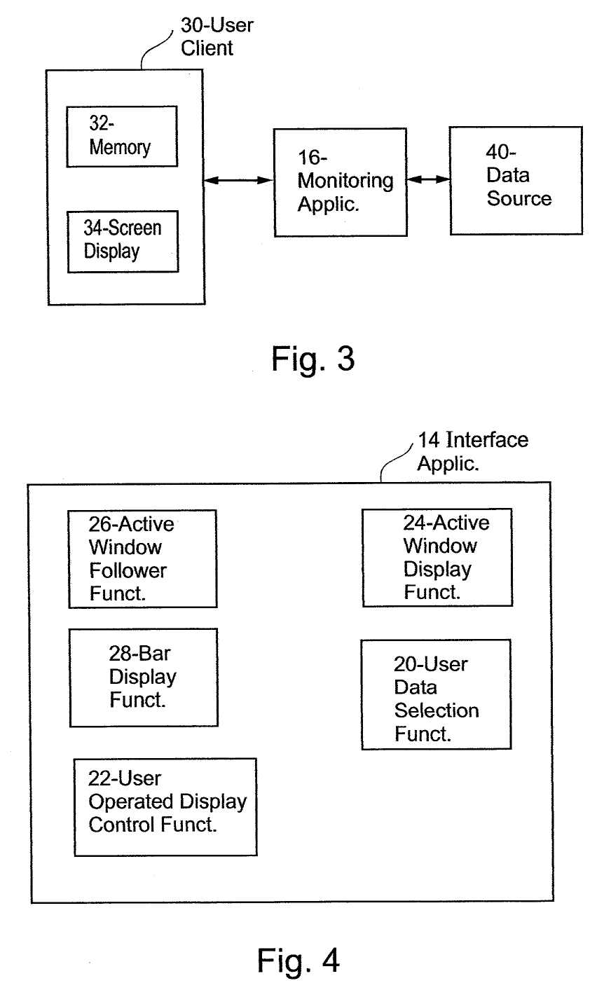

It will be appreciated that portal 10 is capable of accessing Websites and databases without the use of server 12. To illustrate this feature of the preferred embodiment, FIG. 3 is a simplified block diagram which shows user client 30 accessing data from a data source directly and not via a server. In accordance with the preferred embodiment, user client 30 communicates with portal 10 which comprises monitoring application 16 which uploads an agent to each selected data source 40 that is capable of transferring data from that data source directly to user client 30. Data source 40 may be accessible via a communications network or directly.

As used herein, the term “user client” refers to a device which is communication enabled and which allows a user to communicate with other communication enabled devices. A user client can be, for example, a computer, a personal digital assistant (PDA) or a cellular communication device, each being a unique device type as classified according to intended use, mode of communication, mobility and/or the like.

Communication between user client 30 and portal 10 may preferably be effected through a hardwire communication mode (e.g., dial-up, LAN, or WAN) or a wireless communication mode (e.g., infrared or radio frequency) or a combination thereof.

Portal 10 is similarly versatile in its ability to communicate a variety of externally generated data types and data stored in different formats. Such data may consist of text, graphics, audio, video or other digital media. In this regard, server 12 and monitoring application 16 are both capable of storing user identifications, passwords, user selected data preferences and Web site generated parameters to govern their monitoring and downloading functions. Data may include time sensitive notifications, content sensitive notifications, defined changes or updates to Web sites or data sources, or any manner of dynamically changing data such as news, stock prices, weather reports, sports scores, etc.

Server 12 and monitoring application 16 are further designed and configured to store data in the format in which it is retrieved or to convert it to a universal or a cross platform format which is readable by any device type (such as RTF, PDF, HTML, Etc.) or to another more useful format. It is appreciated that further embodiments of portal 10 may incorporate applications for converting data formats. For example, in order to store and manage voice provided data, server 12 may operate a speech to text application which enables conversion of voice data into storable and editable text data.

Data uploaded to user client 30 by server 12 and data directly downloaded by user client 30 from data sources supported by other user clients will typically be stored in memory 32. Memory 32 generally refers to the internal storage capacity of user client 30, but also includes external storage devices, of which many types are known in the art and, indeed, continue to be developed. Certain data may be designated for display on display screen 34 simultaneously with being stored in memory 32 as a result of being so selected by a user. As will be discussed hereinafter, interface application 14 provides a very versatile display capacity, incorporating many different methods, styles and techniques.

FIG. 4 is a simplified black box diagram illustrating the functional components of interface application 14 of data portal 10. The following functions are shown: user data selection function 20 which allows a user to define the type, nature and content of information to be received by user client 30 or to select the sources from which such data will be retrieved; display control function 22 which is a user operable control for expanding, contracting or erasing the display; active window display function 24 for causing information to be displayed integrally in the active one of a number of application windows currently running; active window follower function 26 for maintaining the display in a new active window following exchange with a current active window so that the information displayed therein remains displayed irrespective of having changed the active window; and bar display function 28 for displaying information within a bar either within or docked onto the active application window. Each of the above listed functions will be described hereinafter by way of describing the display capacity of portal 10.

The information to be displayed, as referred to in the preceding paragraph, is governed by the user data selection function 20 of interface application 14, and consists of the externally generated data uploaded to or downloaded by user client 30, either in full or in part or revised; text or graphic notifications that such data has been stored in memory 32 and is available for display; and links or icons which operate to retrieve the data from memory 32 and display it on display screen 34. This information, as so defined, may be displayed in a number of different display types both when user client 30 is on line and off line.

A feature of interface application 14 is active window display function 24 which provides the user client with the capability to display information either within or by docking onto an active window on display screen 34. Pursuant to this function, interface application 14 is able to discern which window of the various application windows that may be running concurrently is active. It may do this by selecting the foreground window based on user interaction and programmatic specification, for example, by using the SetForegroundWindow ( ) command in the API.

Only top-level windows are eligible for docking of the interface. Top-level is defined as windows that are not children of other windows and are not owned. Also a target window for docking preferably satisfies the following requirements:

1. it is an active window;

2. it is visible;

3. it is not in a minimized state (not iconic); and

4. it has a title-bar.

Target windows are sought in the following order:

1. the window currently created or activated;

2. the current foreground window;

3. the window currently at the top of the z-order.

A companion feature to that listed above is interface application 14's active window follower function 26 which provides the capability to maintain a display in a new active window following exchange with a current active window. It is typical of users of computing devices to surf from site to site or to have more than one application window running at any given time. Accordingly, the active window follower function 26 allows the display to follow the user from window to window and provides for continuous display, irrespective of which window is active.

In order for application interface 14 to switch its target window as a new active window is selected, it is preferably able to receive notifications that the active window has been exchanged. Most operating systems' API does not provide such a notification mechanism. However, it is often possible to monitor such events at the system level. This is accomplished in the Windows operating system through the SetWindowsHookEx( ) API. Interface application 14 uses the SetWindowsHookEx( ) API to detect the following events:

Window creation/destruction—when a new active window is created interface application 14 recalculates its target window. This is because the new window has become the foreground window. Likewise, if the window that the display currently docks on is destroyed, application interface 14 will cause the display to move to the next one.

Window activation (focus change)—if a running but inactive window is brought to the foreground, interface application 14 will target that window.

Window movement—if the window that the display is currently within or docked on is moved or resized, interface application 14 will recalculate the relative position to that window. Interface application 14 is capable of detecting drag operation caused by mouse movements and button clicks for locating the window's position.

The above events are detected by installing within interface application 14 the following hooks: WH_CALLWNDPROCRET, WH_CBT and WH_MOUSE. Whenever one of the events specified above is detected, interface application 14 attempts to determine the new target window or the new location of the target window and adjusts the display accordingly.

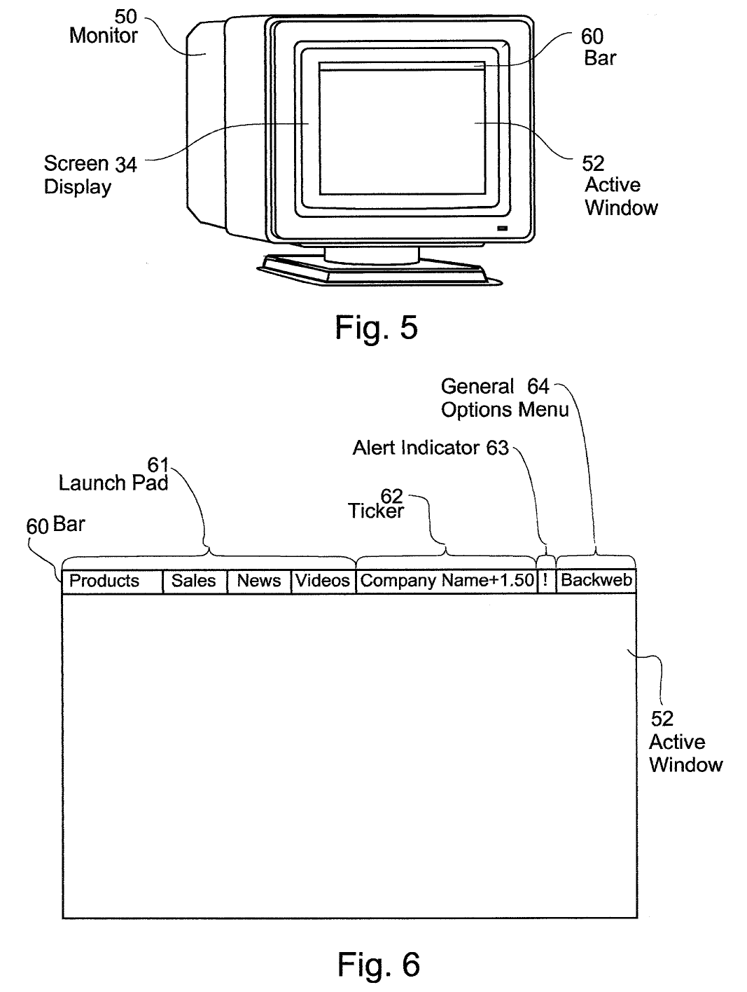

Portal 10 is further capable, via bar display function 28, of displaying information in a very concise display located within a narrow bar within or docked onto the active window. In this connection, reference is now made to FIG. 5, which is a schematic illustration of a monitor 50 showing screen display 34, with the information provided by portal 10 displayed in a bar, hereinafter bar 60, docked at the top of active window 52 displayed on screen display 34. In the described preferred embodiment, bar 60 is docked in a typically unused part of the titlebar and, in its expanded state, may typically consume only 23 pixel rows. Bar 60 stretches across the user's titlebar regardless of the screen resolution. It is appreciated that in further embodiments, bar 60 may be docked or deployed at other locations within or adjacent to the active window, such as at the bottom, on the side of or within the active window and may be expanded in size to suit the requirements of a user.

In the described preferred embodiment, bar 60 is similar to the user interface framework known as a toolbar that docks to the top of a user's screen. Bar 60 is subject to user control via user display control function 22 which allows a user to extend or collapse bar 60 or to make bar 60 invisible or return to visibility.

The above described bar display is to be contrasted with the prior art cited in the background section of this application referred to as “Newstitle”. There are three features that distinguish the preferred embodiment from the prior art. First, whereas the prior art limits normal screen function such as moving the window around the screen and maximizing and collapsing the window, bar display function 28 of interface application 14 does not inhibit any standard Windows functionality. It allows users to click and hold anywhere on the titlebar, including on bar 60 itself, and drag their application around the screen. Second, whereas in prior art the display always takes up the entire span of a Windows titlebar, the display within bar 60 of the preferred embodiment, in its fully expanded window mode, is a fixed 550 pixels wide. On standard screen resolutions (800×600 or 1024×768) 550 pixels takes up at most ¾ of the full screen size. Since most home users fully maximize their Windows application when using them, the display in bar 60 will leave ample spare room in the titlebar. Third, whereas in prior art default text is continually scrolling in the titlebar, text displayed in bar 60 does not scroll. Instead, it subtly dissolves in and out of visibility. It has been found that once the novelty wears off, the vast majority of users have found the continually scrolling text to be extremely distracting and have turned the Newstitle off.

In the described preferred embodiment, bar 60's placement is determined by certain display screen attributes such as the coordinates of the top-left and bottom-right edges of the containing rectangle and the z-order of the target window. This determination is made as a two-step process: first, the target window must be selected. Typically the foreground window is the target window, as described hereinbefore; and second, the target window's z-order value, which indicates which windows are placed above it and which below it, and its screen coordinates must be established. Bar 60 will be placed at an appropriate location relative to those values. If these attributes change, bar 60 will adjust its position automatically. Bar 60 does not interfere with standard title-bar behavior. If the user performs a mouse drag operation on bar 60, the docked-on window will be moved as if the user was dragging its title bar.

Bar 60 serves as a collector of information displayed by interface application 14. In its default state, bar 60 displays launch pad 61, which is an area containing links and icons for accessing data stored in memory 32 and causing that data to be displayed in drop down boxes adjacent to bar 60; a “ticker”, hereinafter ticker 62, for viewing drop down box content headlines; an “alert indicator”, hereinafter alert indicator 63, for accessing certain specifically designated data; and a general options menu 64.

Launch pad 61 is the means by which a user accesses and retrieves data in memory 32. When retrieved, such data is displayed in drop down boxes adjacent to bar 60 which are similar to miniature Web sites. Drop down boxes are content specific user interfaces that display a user's delivered content. Such content may be retrieved and viewed even when user client 30 is offline. Content providers, either the user or the data source publisher, may create their own customized drop down boxes in the authoring language of their choice. For example, an HTML drop down box can be easily created to maintain a consistent look-and-feel with an online Web site.

Users open drop down boxes by clicking the appropriate link or icon in launch pad 61. The selected drop down box appears attached to the bottom of bar 60.

In the preferred embodiment, drop down boxes may be created by publishers of Web sites in order to entice users to view their site content, the use of portal 10 being an incentive for a visit. A user may personalize the content to be received in the drop down box by selecting specific content when downloading the drop down box from a web site. A user can modify the content at any time by clicking the “Personalize” button in the relevant drop down box.

A user can add or delete a drop down box by clicking the “Customize” menu item which is provided in options menu 64 or from pull-down menus appearing in launch pad 61 and ticker 62. Clicking the customize menu item causes the display of a directory of drop down boxes maintained by the publisher of the drop down box currently displayed. Drop down boxes may be added or deleted by clicking on the appropriate item in the directory.

Ticker 62 displays content titles from drop down boxes that have highly dynamic, time-sensitive content such as headline news, stock quotes, weather or sports scores. Clicking on the title text in ticker 62 displays its summary in its drop down box that appears under ticker 62. A user can select a drop down box to display its content in the ticker by clicking the down arrow on the left side of ticker 62 and selecting from a pull-down menu that appears. Text in ticker 62 fades in and out when new titles are available. When no new titles are available, the user's current date and time appear in the ticker.

Alert indicator 63 notifies a user that data has been uploaded to user client 30 that meets specific user determined criteria for immediate notification of the user. Such data constitutes an “alert”. All alerts are aggregated in an alert list which is maintained in memory 32 for retrieval and viewing by a user. Alert indicator 63 contains an icon which turns red when a new alert has been added to the alert list since the last time the alert list was opened. Alert indicator 63 turns grey after the alert list is closed and remains grey until a new alert is added to the list.

When data constituting an alert is received by user client 30, the appropriate alert text in the form of a red alert ticker will slide across the ticker 62 area. Clicking on the alert text displays the alert list with the particular alert highlighted and its summary appearing below it. An “Open” link appears in the summary area allowing the user to click open the full story of the alert. A user may also remove alerts from the alert list. If the user does not interact with the alert ticker, it remains open for 30 seconds and then slides back to its normal position. It will be appreciated that in further embodiments a user may cause the alert ticker to appear in other locations on display screen 34 in order to provide the degree of visibility desired.

Each drop down box can enable a user to set alerts on incoming content. For example, a financial drop down box can enable a user to be notified by an alert when a stock quote reaches a specified high or low price limit. Alerts are set by clicking the “Personalize” button in a drop down box.

It will be appreciated that the above described unique display capacity of portal 10, particularly its capability to provide a versatile and informative display concisely in a typically vacant parcel of display screen real estate, provides an incentive to users to access online content. Thus, portal 10 can be accurately characterized as an offline extension of an on line destination that has the potential to significantly enhance website access and use.

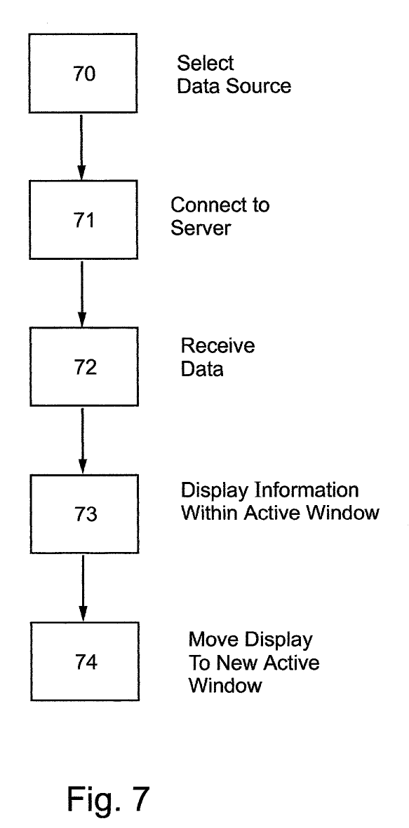

Reference is now made to FIG. 7 which is a flow chart depicting a method of viewing data accessible via a communications network in accordance with the preferred embodiment. The method comprises the steps of selecting at least one data source 70; connecting to a server to monitor the data source and to download data therefrom 71; receiving the data, via the server, from the data source 72; displaying the data along with notification that the data has been stored and links to retrieve the data integrally within an active application window appearing on a screen display 73; and moving the display to a new active window following exchange with a current active window 74. As described hereinbefore, the data is preferably displayed within a bar within the application window, and is displayable independently of the content of the application window.

Similar to the earlier descriptions hereinbefore set forth, bar 60 comprises information superimposed upon the existing window bar functionality and, therefore, does not inhibit the movement or configuration of the application window. The information displayed in bar 60 is configurable to consume less than the entire span of the titlebar, to dissolve in and out of visibility, to become larger and smaller and to display data even when the user client is offline.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather, the scope of the present invention is defined by the appended claims and includes both combinations and subcombinations of the various features described hereinabove as well as variations and modifications thereof which would occur to persons skilled in the art upon reading the foregoing description. Accordingly, it is intended to embrace all such alternatives, modifications and variations that fall within the spirit and broad scope of the appended claims.

What is claimed is:

1. A data portal which comprises
a. at least one server comprising:
monitoring functionality for monitoring and downloading data accessible via at least one communications network, and
selective uploading functionality for uploading at least a selection of said monitored data to at least one user client; and
b. an interface for sending to said at least one user client, said interface comprising: input capability for receiving said selection of monitored data, and active window display functionality for displaying information of said selection of monitored data integrally within an active one of a plurality of application windows.

2. The data portal of claim 1, wherein said interface further comprises active window follower functionality for maintaining said display in a new active window following exchange with a current active window so as to render said information continuously displayable to a user irrespective of exchanging active windows.

3. The data portal of claim 2, wherein at least some of said application windows comprising said plurality of application windows relate to independent applications.

4. The data portal of claim 1, wherein said interface further comprises bar display functionality for displaying said information integrally within a bar within said active one of a plurality of application windows, said information being displayable within said bar independently of a content of a respective application of said active window.

5. The data portal of claim 4, wherein said bar is selected from the group consisting of bars that appear at the top of, at the bottom of, at the side of and central to said active one of a plurality of application windows.

6. The data portal of claim 4, wherein said bar comprises said information superimposed on existing window bar functionality.

7. The data portal of claim 4, wherein said information displayed integrally within said bar is configurable to consume less than the entire span of said bar.

8. The data portal of claim 4, wherein said bar display functionality is configurable to dissolve said information in and out of visibility.

9. The data portal of claim 1, wherein said server further comprises user selection functionality for user definition of said selection of data for uploading.

10. The data portal of claim 1, wherein said interface is capable of storing said uploaded information in a memory of a user client.

11. The data portal of claim 10, wherein said information comprises said selection of data.

12. The data portal of claim 10, wherein said information comprises notification that said selection of data is stored in said memory.

13. The data portal of claim 10, wherein said information comprises at least one link for retrieving said selection of data from said memory.

14. The data portal of claim 1, wherein said interface is capable of displaying said information in said active window when user is offline.

15. The data portal of claim 1, wherein said interface comprises a user operable function for making said information display invisible.

16. The data portal of claim 1, wherein said interface comprises a user operable function for making said information display larger and smaller.

17. The data portal of claim 1, wherein said interface application further comprises a user operable function for revising the configuration of said information display.

18. The data portal of claim 1, wherein said at least one communications network is the Internet.

19. The data portal of claim 18, wherein said at least one server comprises website monitoring and downloading functionality for monitoring and downloading data from at least one website selected by a user.

20. The data portal of claim 19, wherein said monitoring and downloading functionality is capable of identifying data designated by said at least one website for downloading.

21. The data portal of claim 19, wherein said monitoring and downloading functionality is capable of identifying updates and changes to said at least one website.

22. The data portal of claim 19, wherein said monitoring and downloading functionality is capable of identifying dynamically changing data.

23. A data portal in communication with a user client having a screen display and a memory, said data portal comprising
a. a monitoring application which is capable of sending an agent to at least one data source, said agent being capable of monitoring and downloading data therefrom and further capable of transferring said data from said at least one data source to said user client, said user client storing said data in said memory; and
b. an interface application which comprises:
active window display functionality for displaying information integrally within an active one of a plurality of application windows displayed on said screen display, and
active window follower functionality for maintaining said display in a new active window following exchange with a current active window so as to render said information continuously displayable to a user irrespective of exchanging active windows.

24. The data portal of claim 23, wherein at least some of said application windows comprising said plurality of application windows relate to independent applications.

25. The data portal of claim 23, wherein said interface application comprises bar display functionality to display said information within a bar within said active one of a plurality of application windows, said information being displayable within said bar independently of a content of a respective application of said active window.

26. The data portal of claim 25, wherein said bar is selected from the group consisting of bars that appear at the top of, at the bottom of, at the side of and central to said active one of a plurality of application windows.

27. The data portal of claim 25, wherein said bar comprises said information superimposed on existing window bar functionality.

28. The data portal of claim 25, wherein said information displayed integrally within said bar is configurable to consume less than the entire span of said bar.

29. The data portal of claim 25, wherein said bar display functionality is configurable to dissolve said information in and out of visibility.

30. The data portal of claim 23, wherein said monitoring application further comprises user selection functionality for user definition of data for downloading.

31. The data portal of claim 23, wherein said monitoring application is capable of identifying data designated by said at least one data source.

32. The data portal of claim 23, wherein said monitoring application is capable of identifying data comprising at least one update or change to said at least one data source.

33. The data portal of claim 23, wherein said monitoring application is capable of identifying data comprising dynamically changing data.

34. The data portal of claim 23, wherein said information comprises said data stored in said memory.

35. The data portal of claim 23, wherein said information further comprises notification that said data is stored in said memory.

36. The data portal of claim 23, wherein said information further comprises at least one link for retrieving said data from said memory.

37. The data portal of claim 23, wherein said interface application is capable of displaying said information when user is offline.

38. The data portal of claim 23, wherein said interface application further comprises a user operable function for making said information display invisible.

39. The data portal of claim 23, wherein said interface application further comprises a user operable function for making said information display larger and smaller.

40. The data portal of claim 23, wherein said interface application further comprises a user operable function for revising the configuration of said information display.

41. An interface application supportable by a user client, said interface application comprising:
a. active window display functionality for displaying information integrally within an active one of a plurality of application windows, said information being selected from a group consisting of externally generated data, derivatives of externally generated data, notification that externally generated data is stored in a memory of said user client, and links to externally generated data; and
b. active window follower functionality for maintaining said display in a new active window following exchange with a current active window so as to render said information continuously displayable to a user irrespective of exchanging active windows.

42. The interface application of claim 41, wherein at least some of said application windows comprising said plurality of application windows relate to independent applications.

43. The interface application of claim 41, comprising bar display functionality to display said information integrally within a bar within said active one of a plurality of application windows, said information being displayable within said bar independently of a content of a respective application of said active window.

44. The interface application of claim 43, wherein said bar is selected from the group consisting of bars that appear at the top of, at the bottom of, at the side of and central to said active one of a plurality of application windows.

45. The interface application of claim 43, wherein said bar comprises said information superimposed on existing window bar functionality.

46. The interface application of claim 43, wherein said information displayed integrally within said bar is configurable to consume less than the entire span of said bar.

47. The interface application of claim 43, wherein said bar display functionality is configurable to dissolve said information in and out of visibility.

48. The interface application of claim 41, further comprising user selection functionality for user definition of data for display.

49. The interface application of claim 41, being capable of displaying said information when user is offline.

50. The interface application of claim 41, further comprising a user operable function for making said information display invisible.

51. The interface application of claim 41, further comprising a user operable function for making said information display larger and smaller.

52. The interface application of claim 41, further comprising a user operable function for revising the configuration of said information display.

53. A machine-readable storage device storing in a machine readable format an interface application supportable by a user client, said interface application comprising
a. active window display functionality for displaying information integrally within an active one of a plurality of application windows, and
b. active window follower functionality for maintaining said display in a new active window following exchange with a current active window so as to render said information continuously displayable to a user irrespective of exchanging active windows.

54. The storage device of claim 53, wherein at least some of said application windows comprising said plurality of application windows relate to independent applications.

55. The storage device of claim 53, wherein said interface application further comprises bar display functionality to display said information integrally within a bar within said active one of a plurality of application windows, said information being displayable within said bar independently of a content of a respective application of said active window.

56. The storage device of claim 55, wherein said bar is selected from the group consisting of bars that appear at the top of, at the bottom of, at the side of and central to said active one of a plurality of application windows.

57. The storage device of claim 55, wherein said bar comprises said information superimposed on existing window bar functionality.

58. The storage device of claim 55, wherein said information displayed integrally within said bar is configurable to consume less than the entire span of said bar.

59. The storage device of claim 55, wherein said bar display functionality is configurable to dissolve said information in and out of visibility.

60. The storage device of claim 53, wherein said interface application further comprises user selection functionality for user definition of data for display.

61. The storage device of claim 53, wherein said interface application is capable of displaying said information when user is offline.

62. The storage device of claim 53, wherein said interface application further comprises a user operable function for making said information display invisible.

63. The storage device of claim 53, wherein said interface application further comprises a user operable function for making said information display larger and smaller.

64. The storage device of claim 53, wherein said interface application further comprises a user operable function for revising the configuration of said information display.

65. An interface application supportable by a user client, said interface application comprising bar display functionality for displaying information integrally within a bar within an active application window, said information including from at least one of a group consisting of externally generated data, derivatives of externally generated data, notification that externally generated data is stored in a memory of said user client, and links to externally generated data, said bar display functionality being capable of displaying said information in said bar independently of a respective application associated with said active window.

66. The interface application of claim 53, wherein said bar is selected from the group consisting of bars that appear at the top of, at the bottom of, at the side of and central to said active one of a plurality of application windows.

67. The interface application of claim 65, wherein said bar comprises said information superimposed on existing window bar functionality.

68. The interface application of claim 65, wherein said information displayed integrally within said bar is configurable to consume less than the entire span of said bar.

69. The interface application of claim 65, wherein said bar display functionality is configurable to dissolve said information in and out of visibility.

70. The interface application of claim 65, comprising active window follower functionality for moving said information to a bar of a newly active window with exchange of said active window.

71. The interface application of claim 65, further comprising user selection functionality for user definition of data for display.

72. The interface application of claim 65, being capable of displaying said information when user is offline.

73. The interface application of claim 65, further comprising a user operable function for making said information display invisible.

74. The interface application of claim 65, further comprising a user operable function for making said information display larger and smaller.

75. The interface application of claim 65, further comprising a user operable function for revising the configuration of said information display.

76. A method of viewing data accessible via a communications network, comprising the steps of:
a. selecting at least one data source;
b. connecting to a server operable to monitor said at least one user selected data source and to download data therefrom;
c. receiving from said server, said data from said at least one user selected data source;
d. displaying information integrally within an active one of a plurality of application windows appearing on a screen display, said information including one or more selected from the group consisting of said data, notification that said data has been received, and links to said data, and
e. moving said display to a new active window following exchange with a current active window so as to render said information continuously displayable to a user irrespective of exchanging active windows.

77. The method of claim 76, comprising the further steps of storing said data in a memory and retrieving said data from said memory.

78. The method of claim 76, comprising displaying said information integrally within a bar within said active one of a plurality of application windows, said information being displayable within said bar independently of a content of a respective application of said active window.

79. The method of claim 78, wherein said bar is selected from the group consisting of bars that appear at the top of, at the bottom of, at the side of and central to said active one of a plurality of application windows.

80. The method of claim 78, wherein said bar comprises said information superimposed on existing window bar functionality.

81. The method of claim 78, wherein said information displayed integrally within said bar is configurable to consume less than the entire span of said bar.

82. The method of claim 78, wherein said bar display functionality is configurable to dissolve said information in and out of visibility.

83. The method of claim 76, comprising displaying said information when user is offline.

84. The method of claim 76, comprising making said information display invisible.

85. The method of claim 76, comprising making said information display larger and smaller.

86. The method of claim 76, comprising revising the configuration of said information display.

87. The method of claim 76, wherein said communications network is the Internet.

88. The method of claim 76, wherein said at least one data source is a Web site.

89. The method of claim 88, wherein said server is capable of identifying data designated by said at least one website for downloading.

90. The method of claim 88, wherein said server is capable of identifying updates and changes to said at least one website.

91. The method of claim 76, wherein said server is capable of identifying dynamically changing data.

92. A method of supporting continuous display of information at a user client comprising the steps of:
a. supplying at least one user client having a memory and a screen display with an interface application;
b. monitoring at least one data source;
c.. downloading data from said at least one data source;
d. uploading said data to said at least one user client for storage in said memory;
e. via said interface application, retrieving said data from said memory; and
f. via said interface application, displaying information integrally within an active one of a plurality of application windows appearing on said screen display, said information including one or more selected from the group consisting of said data, notification that said data is stored in said memory, and links to said data, said interface application comprising active window follower functionality for maintaining said display in a new active window following exchange with a current active window so as to render said information continuously displayable to a user irrespective of exchanging active windows.

93. The method of claim 92, wherein said interface application comprises bar display functionality to display said information integrally within a bar within said active one of a plurality of application windows independently of a content of a respective application of said active window.

94. The method of claim 93, wherein said bar is selected from the group consisting of bars that appear at the top of, at the bottom of, at the side of and central to said active one of a plurality of application windows.

95. The method of claim 93, wherein said bar comprises said information superimposed on existing window bar functionality.

96. The method of claim 93, wherein said information displayed integrally within said bar is configurable to consume less than the entire span of said bar.

97. The method of claim 93, wherein said bar display functionality is configurable to dissolve said information in and out of visibility.

98. The method of claim 92, wherein said interface application is capable of displaying said information when said at least one user client is offline .

99. The method of claim 92, wherein said interface application comprises a user operable function for making said information display invisible.

100. The method of claim 92, wherein said interface application comprises a user operable function for making said information display larger and smaller.

101. The method of claim 92, wherein said interface application comprises a user operable function for revising the configuration of data within said information display .

102. The method of claim 92, wherein said communications network is the Internet.

103. The method of claim 92, wherein said at least one data source is a website.

104. The method of claim 103, wherein said data is designated by said website;

105. The method of claim 103, wherein said data comprises at least one update or change to said website.

106. The method of claim 93, wherein said data comprises dynamically changing data.

107. A system for viewing data comprising
a. a server capable of accessing at least one data source via a communications network, and having downloading and uploading functionality for downloading data from said data source and uploading said data to a user client; and
b. a user client supporting an interface, said interface comprising:
active window display functionality for displaying information integrally within an active one of a plurality of application windows on said user client independently of a content of a respective application of said active window; and
active window follower functionality for moving said display to a new active window following exchange with a current active window so as to render said information continuously displayable to a user irrespective of exchanging active windows.

108. The system of claim 107, wherein at least some of said application windows relate to independent applications.

109. The system of claim 107, wherein said interface comprises bar display functionality operable to display said information within a bar within said active one of a plurality of application windows.

110. The system of claim 109, wherein said bar is selected from the group consisting of bars that appear at the top of, at the bottom of, at the side of and central to said active one of a plurality of application windows.

111. The system of claim 109, wherein said bar comprises said information superimposed on existing window bar functionality.

112. The system of claim 109, wherein said information displayed integrally within said bar is configurable to consume less than the entire span of said bar.

113. The system of claim 109, wherein said bar display functionality is configurable to dissolve said information in and out of visibility.

114. The system of claim 107, wherein said interface further comprises user selection functionality for user definition of said data for uploading.

115. The system of claim 107, wherein said interface is capable of storing said information in said memory.

116. The system of claim 115, wherein said information comprises said data.

117. The system of claim 115, wherein said information further comprises notification that said data is stored in said memory.

118. The system of claim 115, wherein said information further comprises at least one link for retrieving said data from said memory.

119. The system of claim 107, wherein said interface is capable of displaying said information when said user is offline.

120. The system of claim 107, wherein said interface further comprises a user operable function for making said information display invisible.

121. The system of claim 107, wherein said interface further comprises a user operable function for making said information display larger and smaller.

122. The system of claim 107, wherein said interface further comprises a user operable function for revising the configuration of said information display.

123. The system of claim 107, wherein said communications network is the Internet.

124. The system of claim 123, wherein said at least one data source is a website.

125. The system of claim 124, wherein said server comprises recognition functionality for recognizing for download, data designated by said website.

126. The system of claim 124, wherein said server comprises recognition functionality for recognizing for downloading, at least one of updates and changes to said website.

127. The system of claim 107, wherein said server comprises recognition functionality for recognizing for download, data comprising dynamically changing data.
